(19) United States
(12) Patent Application Publication
(10) Pub. No.: US 2007/0227827 A1
(43) Pub. Date: Oct. 4, 2007

(54) Emergency Device For The Raising Or Lowering Of Elevators Trapped Between Floors

(75) Inventor: Miguel Angel Madoz Michaus, Hernani Guipuzcoa (ES)

Correspondence Address: OSTROLENK FABER GERB & SOFFEN, 1180 AVENUE OF THE AMERICAS, NEW YORK, NY, 100368403, US

(73) Assignee: S. COOP ORONA, Hernani Cuipuzcoa (ES)

(21) Appl. No.: 11/568,677

(22) PCT Filed: Jul. 5, 2004
(86) PCT No.: PCT/ES04/00319

§ 371 Date: Nov. 3, 2006

(30) Foreign Application Priority Data
May 4, 2004 (ES) P 200401068

(51) Int. Cl. B66B 9/00

(52) U.S. Cl. 187/277; 187/250

(57) ABSTRACT

The invention relates to an emergency device for the raising or lowering of elevators trapped between floors comprising a first geared motor (1) transmitting a rotational movement to the output shaft of the traction machine (3) of the car of the elevator in the emergency situation with the elevator trapped between floors. This first geared motor (1) is connected by means of a cable (33) to a second direct current geared motor (8) located in a control cabinet (44) which upon rotating, acts like a generator feeding electric current to the first geared motor (1), a manual actuation crank (43) determining the mentioned rotational movement being coupled to the second geared motor (8). In order to prevent the reversal of energy flow, it has a two-way clutch (4) or micro-circuit breakers (35, 36) braking the first geared motor (1) when the actuation crank (43) starts rotating due to this reversal of flow.

### OBJECT OF THE INVENTION

The present invention relates to an emergency device used to move the passenger car of an elevator when the elevator is not working, either due to a lack of electric current or due to the failure of any part of the installation. The device allows moving the car safely until it is leveled with one of the floors of the building so that the passengers can leave said car without the difficulties that arise when the latter stops between two floors.

An object of the invention is to provide the device with the necessary means so that the rescue operation does not require an excessive effort while at the same time the operation can be carried out with the sufficient speed so that the trapped passengers do not have to wait for an exaggerated period of time.

Another object of the invention is to incorporate a manual actuation mechanical solution combined with the generation of electricity to feed the transmission members determining the controlled movement of the elevator, for the purpose of ensuring the operative and device assembling flexibility while at the same time ensuring the reliability of its components.

### BACKGROUND OF THE INVENTION

When a failure occurs in the operation of an elevator, it is usual for it to occur in an unexpected manner during its movement with occupants therein and for the elevator to stop at a level other than the shaft opening of one said floors, which makes the exit of the occupants from the elevator difficult.

In view of said emergency situation, several systems have been developed the aim of which is to facilitate the rescue or evacuation of the occupants trapped in the elevator, these systems having in common the incorporation of means complementary to the ones normally used to raise and lower the elevator, which aid in taking the elevator closer to the opening of one of the floors so as to allow a more comfortable exit of the occupants.

This is the case of patent US 2002/0148687 for example, which relates to an emergency device for the raising or lowering of an elevator, including an auxiliary motor which makes a pinion rotate, which pinion is geared to a gear wheel which is in turn geared to another gear wheel, both gear wheels having corresponding drums in which the cables that are normally used for raising and lowering the elevator are wound. Said cables run through pulleys located on the elevator, as well as through traction pulleys located at an upper level in the shaft of the elevator, a counterweight hanging from their ends.

In the event of a failure in the installation, in the situation in which the traction pulleys are locked, the mentioned auxiliary motor is activated and will act in one direction or the other determining the raising or lowering of the elevator to the closest floor.

This system includes detection means indicating when the car is leveled with one of the floors and acting on the auxiliary motor, thus stopping the elevator so as to facilitate the evacuation of the passengers safely and comfortably.

Patent US 2002/0125076 describes an emergency device for elevators which also incorporates an independent feed auxiliary motor, which through a clutch mechanism is coupled on the rotating shaft of the main motor, making it rotate and determining the raising or lowering for nearing the elevator. It also has a manual emergency system consisting of cables which are accessed through a window made in the car and are gripped with the hands to pull them and which act on a hydraulic cylinder causing the raising or lowering of the car.

Patent EP 1 165 424 describes an elevator with a rescue system based on the incorporation of switches controlling the partial release of the elevator motor brake so as to make the elevator move downwards to the desired position for the safe disembarkation of its occupants, complementarily having sensors and indicators which determine when the elevator reaches this position.

Electric systems are not completely reliable and are normally based on the operation of independent equipment that is not used regularly and is therefore not always in suitable maintenance conditions.

Patent WO 02/096790 is included in the mechanical solutions proposed in this field and describes the incorporation of a key actuated by a rotating lever which acts on a gear wheel connected to the driving element of the elevator.

Other systems for the emergency evacuation from elevators, such as the one described in patent EP 0 990 614, incorporate a lever releasing the brake of the main actuation motor of the elevator and a pulling mechanism moving a pinion until it is geared to a rear gear wheel linked to the shaft of the main motor. This mechanism is complemented with a crank mechanism which makes the pinion rotate once it is geared and which in turn makes the gear wheel and therefore the shaft of the motor rotate, causing the manual raising or lowering of the elevator.

### DESCRIPTION OF THE INVENTION

The emergency device forming the object of this invention is applicable for carrying out the raising or lowering of an elevator trapped between floors and its main feature is that the machine of the elevator is moved in this emergency situation by means of an auxiliary motor or geared motor geared thereto. Said motor or geared motor receives the energy of a generator connected thereto by means of an electric cable, which generator produces electric energy as a result of its manual actuation by the person carrying out the rescue, preferably by means of a crank.

The emergency device includes mechanical elements that can release the brake of the machine of the elevator from a distance, so that the aforementioned motor or geared motor can act easily, but it is even able to act without releasing the brake is it is designed to operate this way, thus preventing the risks inherent to the brake release operation and reducing the cost of the system.

The device is actuated by a simple crank, therefore the selection of the direction of the raising or lowering movement of the elevator during the rescue operation is carried out naturally by just rotating the crank in one direction or the other.

Another proposed advantage relates to the fact that a system is provided preventing the reverse flow of energy which may be generated from the machine as a result of an unbalance thereof and which is directed towards the system operation elements, preventing an uncontrolled movement of the crank, and therefore dangerous situations from occurring. In this sense, the incorporation of a clutch is contemplated in a possible solution and the incorporation of micro-circuit breakers in the rotating crank that prevent flow reversal is contemplated in another alternative solution.

Given that direct current motors can be used as such (providing them with electric energy and obtaining a torque), as well as generators (actuating them with an external torque and obtaining electric energy therefrom), the same direct current motor can be used, in this case there are corresponding micro-circuit breakers located in the machine and in the control cabinet, thus simplifying manufacture and assembly and reducing the cost.

Although the system object of the invention is especially suitable for its use in elevators without machine rooms, its simplicity and reduced cost also allows its installation in elevators having said room.

### DESCRIPTION OF THE DRAWINGS

To complement the description which is being made and with the aim of aiding to better understand the features of the invention according to a preferred practical embodiment thereof, a set of drawings is attached as an integral part of said description in which the following is shown with an illustrative and non-limiting character:

FIG. 1 shows a general schematic view of the machine of the elevator with the part of the device that is assembled in the machine itself. The machine is shown in the rest situation, i.e. when it is not being used.

FIG. 2 shows a partial view of the device, including the actuation thereof in the control cabinet.

FIG. 3 shows a partial view of FIG. 2 in which the geared motor acting on the machine is observed.

FIG. 4 shows a partial view of the assembly of the mentioned geared motor of FIG. 3 with its gears seen from behind.

FIG. 5 shows a front view of the device in the situation in which it is activated.

FIG. 6 shows an alternative embodiment of the device without a clutch, in which an elevational plan view and a front view of detail C are observed in which the micro-circuit breakers responsible for preventing the reversal of energy flow are shown.

FIG. 7 shows a detail of the several states of the contacts of the micro-circuit breakers which are acted upon to ensure that the reversal of the generated energy flow does not occur.

### PREFERRED EMBODIMENT OF THE INVENTION

The invention briefly described above and defined by the following claims can be detailed with the following description which is accompanied by the attached figures in order to understand it better.

The present invention is applicable to elevators essentially consisting of a car incorporating a machine (3) which is associated at its output shaft to a transmission (40) which determines the rotation of traction pulleys (41) causing the raising or lowering of the car of the elevator by means of the corresponding cables, and consisting of an inertia flywheel (42) on which a brake (5) acts when the elevator is in the stopped situation.

The emergency device set forth in this invention consists of two distinguished parts. This first part, the driving part, is in the machine (1) itself of the elevator, whereas the second part is in a control cabinet (44) and comprises an actuation crank (43) and an actuation lever (17) of the brake (5) which keeps the output shaft of the machine (3) and therefore the car locked.

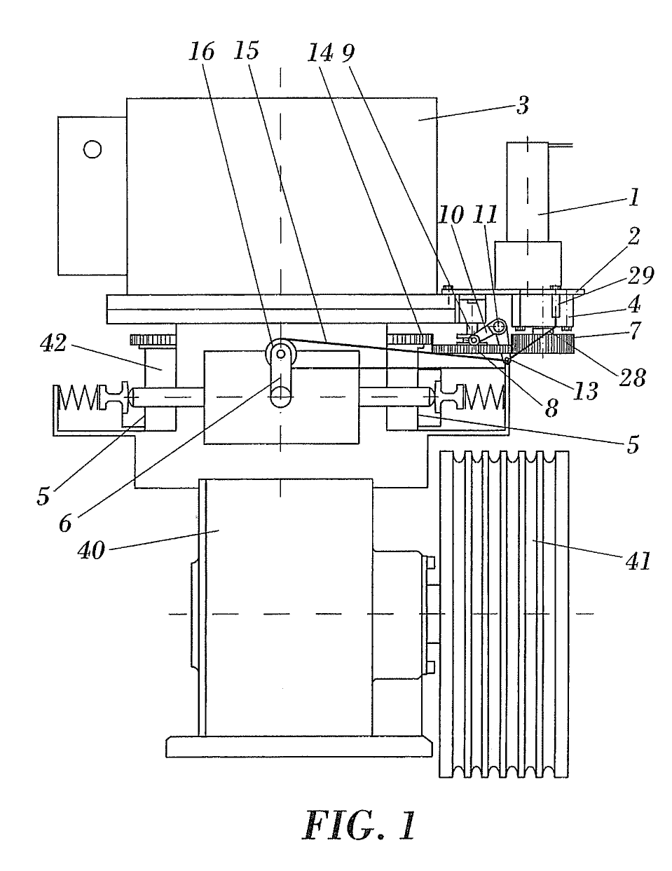

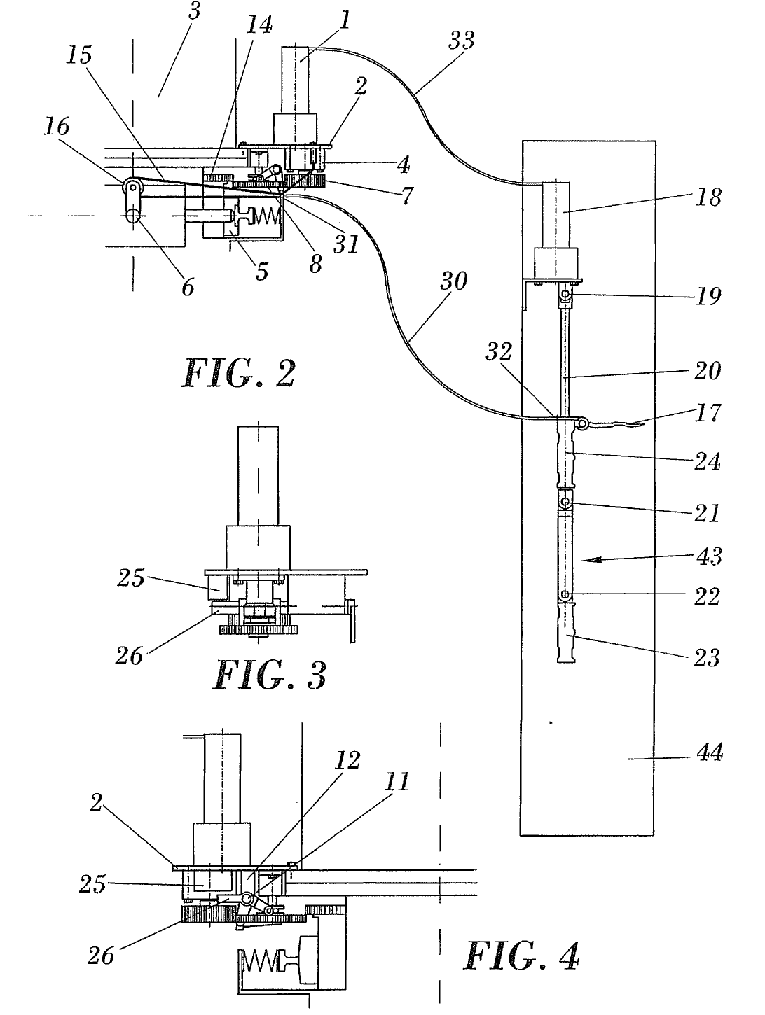

The elements of the driving part are observed in FIGS. 1, 2, 3 and 4. Said driving part consists of a first direct current geared motor (1) screwed to a plate (2) which is turn screwed to the casing of the machine (3). A first embodiment contemplates that at the output of the shaft of the first geared motor (1) there is arranged a two-way clutch (4) allowing the movement from the geared motor (1) towards the machine (3) in any of the two rotating directions, but preventing the movement from the machine (3) towards the geared motor (1). This arrangement prevents the machine from rotating by itself due to the unbalance of the masses of the car and the counterweight when the brake (5) locking the machine (3) is released, and prevents the movement from being transmitted towards the first geared motor (1).

Linked at the output of the first geared motor (1), in this case with the interposition of the two-way clutch (4), there is a driving gear (7) with a greater width than another intermediate gear (8) sliding with respect to its central shaft (9) without uncoupling from the driving gear (7). The intermediate gear (8) occupies an upper position when it is pushed by a fork (10) joined to the end of a shaft (11) which rotates assembled on a fixed support (12) screwed to the lower face of the plate (2).

The shaft (11) is linked at its other end, on the other side of the support (12), to a lever (13). Both the fork (10) and the lever (13) are joined to the shaft (11) by means of cross pins or by other means ensuring both the radial and axial fixing.

When it occupies its upper position, the intermediate gear (8) is geared with the driving gear (7) and simultaneously with a gear of the machine (14) which is screwed to the upper part of the inertia flywheel (42) of the machine (3). At this time, the intermediate gear (8) works as a parasite, transmitting the movement from the driving gear (7) to the gear of the machine (14).

Linked to the lever (13), there is an end of braided steel cable (15) which passes through a roller (16) of a brake-releasing lever (6) and is secured at its other end to the actuation lever (17) which is in the control cabinet. The cable (15) has a coating sheath (30) extending from a support (31) of the machine (3) to a support (32) of the actuation crank (43) located in the control cabinet (44).

The incorporation of a traction spring (28) linked at one end to the lever (13) and at its end to a support (29) fixed to the plate (2) is contemplated to facilitate the recovery of the extended position of the actuation lever (17) To prevent the machine from running inconveniently during the rescue process, the incorporation of a micro-circuit breaker (25) secured to the plate (2) is contemplated, as can be seen in FIG. 4, which micro-circuit breaker is permanently pulsed by a cut-off lever (26) integral with the shaft (11) when the device is not used.

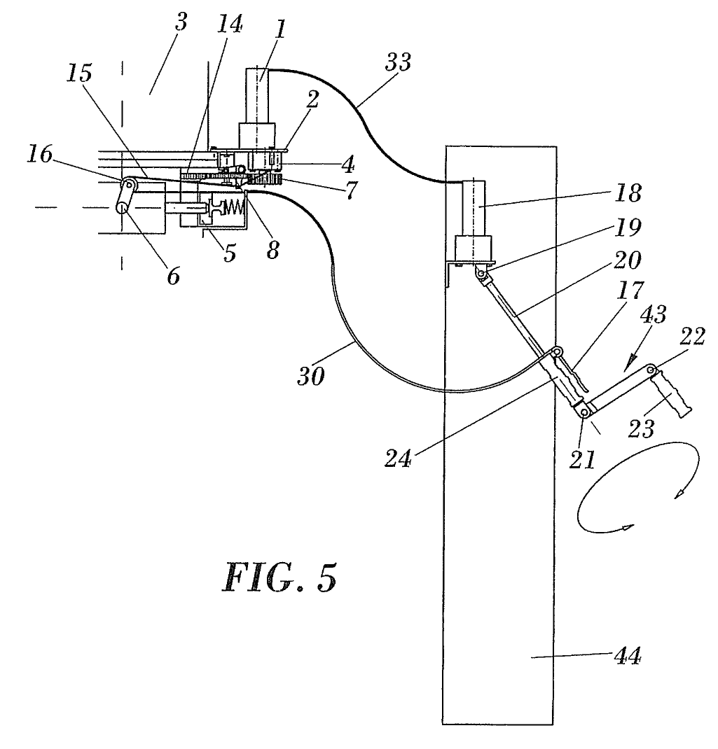

Inside the control cabinet and in its upper part, there is a second direct current geared motor (18) from the shaft of which hangs a hinged bar (20) by means of a cardan joint (19). The bar (20) can be bent through hinges (21) and (22) to adopt the shape of an actuation crank (43), as can be seen in FIG. 5.

Grips (23) and (24) rotate loosely on the bar (20), which grips are held by the user making the crank (43) and therefore the bar (20) rotate.

The terminals of the first geared motor (1) located on the part of the machine (3) and the terminals of the second geared motor (18) located in the control cabinet (44) are joined by means of an electric cable (33).

The manner of operating the device is described below in view of FIG. 5:

When for any reason the elevator stops between two floors and does not respond to the controls, it is necessary to rescue it, i.e. it must be raised to the floor immediately above it or lowered to the floor immediately under it.

To that end, it is necessary to access the control cabinet (44), remove the bar (20) from its housing and bend the hinges (21) and (22) in order to shape the crank. The actuation lever (17) is then rotated to its retracted position causing the traction of the cable (30) which causes the rotation of the lever (13) around the shaft (11) as well as the rotation of the brake-releasing lever (6).

The rotation of the lever (13) makes the gear (8) move upwards to its upper position pushed by the fork (10), the gears (7), (8) and (14) thus being geared to transmit the movement from the first geared motor (1) to the machine (3). Simultaneously, and as a result of the rotation of the lever (13), the rotation of the cut-off lever (26) which kept the micro-circuit breaker (25) actuated also rotates, the machine (3) thus being disconnected from the general electrical circuit.

The rotation of the lever (6) causes the release of the brake (5) which is pressed against the inertia flywheel (42) of the machine (3), the fast shaft of the machine (3) being free. If when the brake (5) is released, the car tends to move upwards or downwards due to the unbalance existing between the car and the counterweight, the shaft of the machine together with the gear (14) of the machine (3) will start to rotate, this movement being transmitted to the first geared motor (1). However, this movement is locked by the two-way clutch (4), which does not allow the movement in that direction, in any of the rotating directions.

Then, keeping the actuation lever (17) permanently retracted with one hand on the grip (24) and the other hand on the other grip (23), the crank (43) is rotated, causing the rotation of the bar (20) and with it the shaft of the second geared motor (18).

When the shaft of the second geared motor (18) is rotated, the latter starts working like a generator producing a voltage between its terminals. The electric cable (33) joining the terminals of the second geared motor with the terminals of the first geared motor (1) allows the current generated in the second geared motor (18) to feed the first geared motor (1), making the latter rotate.

The movement of the first geared motor (1) is transmitted by the gears (7), (8) and (14) to the output shaft of the machine, thus causing the movement of the car.

The rescue movement of the car can occur in any of the two directions, i.e. upwards or downwards according to the direction in which the crank (43) is rotated.

The rescue process has concluded once the car has reached a floor level. Then the actuation lever (17) is released to its open position. With this action, the brake (5) of the machine (3) returns to its braking position and the intermediate gear (8) returns to its lower position actuated by the traction spring (28), the gear (14) of the machine (3) being disconnected from the rescue system.

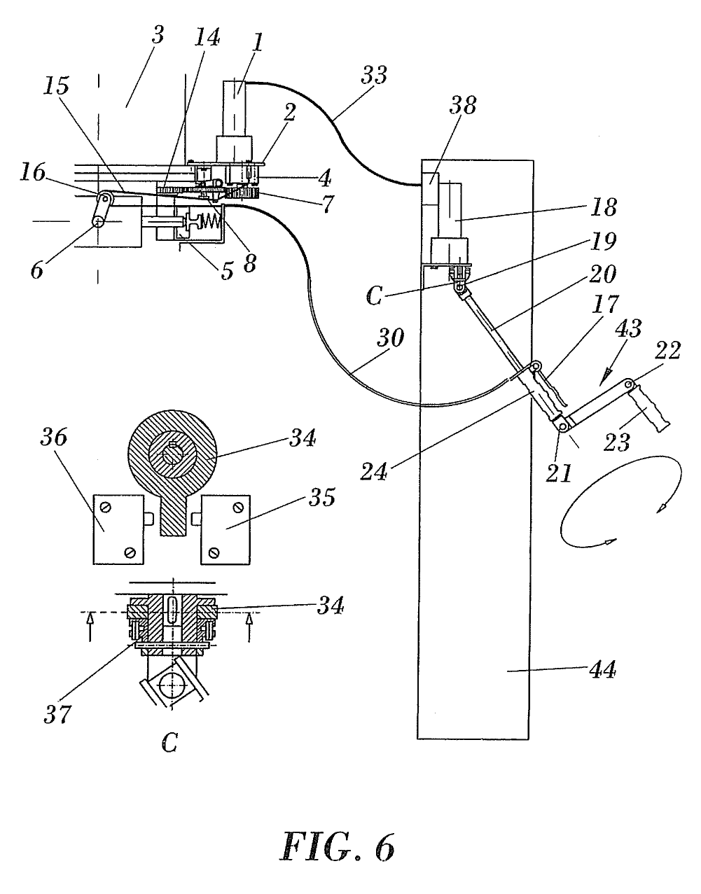

FIG. 6 shows an alternative embodiment in which the device lacks a clutch (4). In this case it incorporates micro-circuit breakers (35, 36) which prevent the reversal of energy flow that may be caused by the movement of the car in an unbalanced situation with the counterweight. The micro-circuit breakers are located around the cardan shaft (19) actuating the second geared motor (18) working like a generator.

On said cardan shaft (19) there is a bushing (34) tightened against a rib of said shaft by means of a spring (37). When the shaft (20) rotates as a result of the reversal of energy flow, the cardan shaft (19) transmits a small turning torque to the bushing (34). The bushing (34) has a projection located between two micro-circuit breakers (35, 36), therefore when the cardan joint (19) rotates it will actuate one of the micro-circuit breakers (35, 36) according to the direction in which the crank (43) is rotated. If the crank (43) continues rotating, the bushing (34) will not continue to rotate and will slide on the cardan shaft (19).

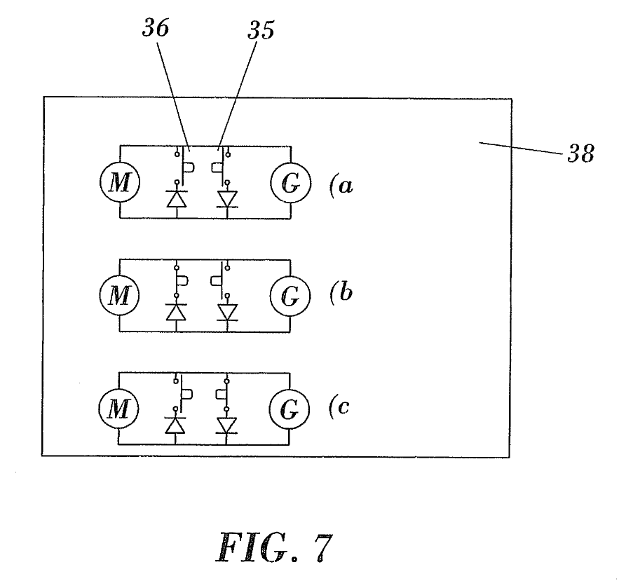

The contacts of the micro-circuit breakers (35, 36) are connected in the electric circuit joining the second geared motor (18) and the first geared motor (1) through diodes in the manner shown in FIG. 7, in which the different states of the contacts of the micro-circuit breakers (35, 36) are shown.

The manner of operating the system is the following:

When the rescue process is started and the actuation lever (17) is rotated so as to release the brake (5) of the machine (3), the car may have a tendency to move downwards or upwards according to its being heavily loaded or not too loaded. At this time, the movement of the machine will be transmitted to the first geared motor (1) which will start working like a generator. The current produced by the first geared motor (1) will make the second geared motor (18), together with the crank (43) and the bushing (34), start rotating. The rotation of the busing (34) determines the actuation of one of the micro-circuit breakers (35, 36) according to the rotation direction. The electrical circuit will adopt one of the states (b) or (c) of FIG. 7. In other words, the first geared motor (1) will be short circuited through one of the diodes, which will cause the braking of the first geared motor (1) and the slowing of the movement of the car.

In this situation, it would not be necessary to use the crank (43) to rescue the car, it would only be necessary to leave the car to move slowly towards the level of a floor and brake the machine again by releasing the actuation lever (17). If the unbalance of the car with respect to the counterweight is not great enough for the car to continue moving upon short circuiting the first geared motor (1), the crank (43) would be used and the rescue would be carried out as in the previous case.

1. An emergency device for the raising or lowering of elevators trapped between floors applicable in elevators consisting of a car incorporating a machine associated at its output shaft to a transmission determining the rotation of traction pulleys causing the raising or lowering of the car of the elevator by means of corresponding cables, and having an inertia flywheel on which a brake acts in its elevator stop situation, wherein it comprises:
a first direct current geared motor transmitting a rotational movement to the output shaft of the machine in the emergency situation with the trapped elevator,
a second direct current geared motor located in a control cabinet and actuated by a manual crank acting as a generator feeding electric current to the first geared motor, and
an electric cable connecting the first geared motor with the second geared motor.

2. An emergency device for the raising or lowering of elevators trapped between floors according to claim 1, wherein it comprises transmission means that can be coupled and uncoupled between the first geared motor and the machine.

3. An emergency device for the raising or lowering of elevators trapped between floors according to claim 2, wherein the transmission means comprise a driving gear associated to the first geared motor, a gear of the machine assembled on the inertia flywheel and a movable intermediate gear that couples or uncouples the driving gear to the gear of the machine.

4. An emergency device for the raising or lowering of elevators trapped between floors according to claim 3, wherein the intermediate gear is assembled in a sliding manner with respect to a central shaft and is linked to a rotating fork associated by means of a cable to an actuation lever located in the control cabinet determining the rotation of the fork and the coupling or uncoupling of the intermediate gear with the gear of the machine.

5. An emergency device for the raising or lowering of elevators trapped between floors according to claim 4, wherein the fork is joined to an end of a shaft which rotates assembled on a fixed support, the other end of which is linked to a lever to which the cable is coupled.

6. An emergency device for the raising or lowering of elevators trapped between floors according to claim 4, wherein the cable passes through a roller of a brake-releasing lever releasing the brake upon activating the actuation lever.

7. An emergency device for the raising or lowering of elevators trapped between floors according to claim 5, wherein the lever is linked to one end of a traction spring which is associated at its other end to a fixed support to facilitate the recovery of the position of the actuation lever.

8. An emergency device for the raising or lowering of elevators trapped between floors according to claim 1, wherein at the output of the shaft of the first geared motor stand before the driving gear there is a two-way clutch allowing the movement from the first geared motor to the machine in any of the two rotating directions, but preventing the movement from the machine to the first geared motor.

9. An emergency device for the raising or lowering of elevators trapped between floors according to claim 1, wherein the actuation crank makes a cardan shaft acting on the second geared motor rotate.

10. An emergency device for the raising or lowering of elevators trapped between floors according to claim 9, wherein a bushing is arranged on the cardan shaft which is provided with a projection located between micro-circuit breakers with which it contacts, braking the first geared motor when the rotation of the cardan shaft occurs as a result of the reversal of energy flow between the first geared motor and the second geared motor due to the movement of the car in an unbalanced situation with the counterweight.
